(19) United States
(12) Patent Application Publication
(10) Pub. No.: US 2011/0305163 A1
(43) Pub. Date: Dec. 15, 2011

(54) COMMUNICATION SYSTEM, COMMUNICATION APPARATUS, AND COMMUNICATION METHOD

(75) Inventor: Daisuke Toyama, Kanagawa (JP)

(73) Assignee: KYOCERA CORPORATION, Kyoto (JP)

(21) Appl. No.: 13/203,398

(22) PCT Filed: Feb. 25, 2010
(86) PCT No.: PCT/JP2010/053010

§ 371 Date: Aug. 25, 2011

(30) Foreign Application Priority Data
Feb. 25, 2009 (JP) 2009-043177

(51) Int. Cl. H04W 24/00

(52) U.S. Cl. 370/252

(57) ABSTRACT

A radio base station (1) determines, based on the condition of an uplink communication channel, an element of the feedback of a code block communication quality, which is the quality of a downlink communication channel, by a radio terminal (2). Further, the radio base station (1) transmits feedback control information including a mode of the feedback to the radio terminal (2). On the other hand, the radio terminal (2) determines, based on the received feedback control information, the mode of the feedback and uses the uplink communication channel to transmit the code block communication quality, which is the quality of the downlink communication channel, to the radio base station (1). The radio base station (1) performs, based on the received code block communication quality, a retransmission control of the code block.

### TECHNICAL FIELD

The present invention relates to: a communication system including two communication apparatuses, and performing data communication between the two communication apparatuses; a communication apparatus in the communication system; and a communication method in the communication system.

### BACKGROUND ART

Hybrid automatic repeat request (HARQ) is employed for communications between a radio base station and a radio terminal, in some cases. The HARQ improves error detectability in the receiver by using automatic repeat request (ARQ) and an error detection using a forward error code (FEC) in combination.

Specifically, the radio base station transmits the same bit sequence multiple times. The radio terminal combines the same bit sequences received multiple times and determines the value of each bit based on the result of the combination. Thus, time diversity effect is obtained and the error detectability improves.

The radio base station may divide the bit sequence in sections known as code blocks of a certain length, and transmit the resultant bit sequence if required for convenience in calculation processing of a decoder in the radio terminal.

For example, in the technique disclosed in Patent Document 1, the radio base station divides an information bit sequence into multiple blocks. The radio base station adds a CRC (Cyclic Redundancy Check) bit sequence that is an error detection code to each of the blocks to generate a code block. The radio base station encodes and then transmits the code blocks. On the other hand, the radio terminal decodes each of the code blocks and detects an information bit sequence error included in the code blocks based on the CRC bit sequences included in the code blocks.

### PRIOR ART DOCUMENT

### Patent Document

Patent Document 1: Japanese Patent Application Publication No. 2005-295192

### SUMMARY OF THE INVENTION

In the technique described in Patent Document 1, a radio terminal in which an information bit sequence error has occurred performs a predetermined feedback to request retransmission to a radio base station. Unfortunately, such a feedback imposes load on a communication channel (uplink communication channel) in the direction from the radio terminal to the radio base station, and thus can hinder the transmission of voice data and the like using the uplink communication channel.

In view of the above problem, an objective of the present invention is to provide a communication system, a communication apparatus, and a communication method that can achieve an appropriate feedback control not hindering the data transmission.

In order to solve the objective described above, the present invention has the following features. According to a first feature of the present invention, there is provided a communication system (radio communication system 10) comprising a first communication apparatus (radio base station 1) and a second communication apparatus (radio terminal 2) and configured to allow communication of data between the first communication apparatus and the second communication apparatus, wherein the first communication apparatus comprises: a determination section (feedback control information generator 165) configured to determine a feedback factor for feedback in which the second communication apparatus provides the first communication apparatus with information indicating a quality of second communication in the direction from the first communication apparatus to the second communication apparatus, on the basis of a condition of a first communication in the direction from the second communication apparatus to the first communication apparatus; a data transmitter configured to transmit to-be-transmitted data to the second communication apparatus; and a feedback factor transmitter (feedback control information transmitter 166) configured to transmit information indicating the feedback factor determined by the determination section to the second communication apparatus, the second communication apparatus comprises: a data receiver (radio communication section 206) configured to receive the to-be-transmitted data from the first communication apparatus; a measurement section (communication quality measurement section 258) configured to measure the quality of the second communication; a feedback factor receiver (feedback control information receiver 264) configured to receive information indicating the feedback factor from the first communication apparatus; and a quality transmitter (communication quality transmitter 266) configured to transmit, to the first communication apparatus, information indicating the quality of the second communication measured by the measurement section on the basis of the information indicating the feedback factor received by the feedback factor receiver, and the first communication apparatus further comprises: a quality receiver (radio communication section 106) configured to receive the information indicating the quality of the second communication from the second communication apparatus; and a retransmission controller (rate matching sections 158-1, 158-2, 158-3, code block combiner 160, transmission unit setting section 162) configured to control retransmission in the second communication on the basis of the information indicating the quality of the second communication received by the quality receiver.

In such a communication system, the first communication apparatus determines the factor of the feedback for the quality of the second communication performed by the second communication apparatus on the basis of the condition of the first communication and transmits the information indicating the feedback factor to the second communication apparatus. On the other hand, the second communication apparatus transmits the information indicating the quality of the second communication in accordance with the notified information indicating the feedback factor.

Thus, the second communication apparatus can transmit the quality of the second communication using the first communication in the feedback mode based on the condition of the first communication, and thus an appropriate feedback control not hindering the transmission of the voice data and the like using the first communication can be achieved.

According to a second feature of the present invention, there is provided a communication apparatus configured to perform communication of data with a different communication apparatus, the communication apparatus comprising: a determination section configured to determine a feedback factor of information indicating a quality of second communication in the direction from the communication apparatus to the different communication apparatus, on the basis of a condition of a first communication in the direction from the different communication apparatus to the communication apparatus; a data transmitter configured to transmit to-be-transmitted data to the different communication apparatus; a feedback factor transmitter configured to transmit information indicating the feedback factor determined by the determination section to the different communication apparatus; a quality receiver configured to receive the information indicating the quality of the second communication transmitted from the different communication apparatus; and a retransmission controller configured to control retransmission in the second communication on the basis of the information indicating the quality of the second communication received by the quality receiver.

A third feature of the present invention is according to the second feature and is summarized as follows. The determination section determines the feedback factor in such a manner that the worse the quality in the first communication is, the more the timing and amount of information are limited for the feedback in which the different communication apparatus provides the information indicating the quality of the second communication.

A fourth feature of the present invention is according to the second feature and is summarized as follows. The determination section determines the feedback factor in such a manner that the smaller the free capacity in the first communication is, the more the timing and amount of information are limited for the feedback in which the different communication apparatus provides the information indicating the quality of the second communication.

A fifth feature of the present invention is according to the second feature and is summarized as follows. The determination section determines the feedback factor in such a manner that the larger the used capacity in the first communication by the other communication apparatus is, the more the timing and amount of information are limited for the feedback of the information indicating the quality of the second communication.

A sixth feature of the present invention is according to the second feature and is summarized as follows. The determination section determines the feedback factor in such a manner that the higher the QoS required for a communication using the first communication by the different communication apparatus is, the more the timing and amount of information are limited for the feedback of the information indicating the quality of the second communication.

A seventh feature of the present invention is according to the second feature and is summarized as follows. The communication apparatus communicates packets including a plurality of code blocks obtained by dividing a bit sequence, with the different communication apparatus, and the determination section determines the factor for the feedback of the information indicating the quality of the code blocks.

According to an eighth feature of the present invention, there is provided a communication apparatus configured to perform communication of data with a different communication apparatus, the communication apparatus comprising: a data receiver configured to receive to-be-transmitted data from the different communication apparatus; a measurement section configured to measure the quality of a first communication in the direction from the different communication apparatus to the communication apparatus; a feedback factor receiver configured to receive from the different communication apparatus, information indicating a feedback factor for information indicating a quality of a second communication in the direction from the communication apparatus to the different communication apparatus; and a quality transmitter configured to transmit, to the different communication apparatus, information indicating the quality of the first communication measured by the measurement section, on the basis of the information indicating the feedback factor received by the feedback factor receiver.

A ninth feature of the present invention is according to the eighth feature and is summarized as follows. When the feedback factor receiver receives no information indicating the feedback factor within a predetermined period of time after the data receiver receives the to-be-transmitted data, the quality transmitter transmits, to the first communication apparatus, the information indicating the quality of the first communication measured by the measurement section, on the basis of a specific feedback factor.

A tenth feature of the present invention is according to the eighth feature and is summarized as follows. The communication apparatus communicates packets including a plurality of code blocks obtained by dividing a bit sequence, with the other communication apparatus, and the measurement section measures the quality of the code blocks.

According to an eleventh feature of the present invention, there is provided a communication method in a communication system comprising a first communication apparatus and a second communication apparatus and configured to allow communication of data between the first communication apparatus and the second communication apparatus, the method'comprising the steps of: determining, by the first communication apparatus, a feedback factor for feedback in which the second information apparatus provides the first communication apparatus with information indicating a quality of second communication in the direction from the first communication apparatus to the second communication apparatus, on the basis of a condition of a first communication in the direction from the second communication apparatus to the first communication apparatus; transmitting to-be-transmitted data from the first communication apparatus to the second communication apparatus; transmitting information indicating the determined feedback factor from the first communication apparatus to the second communication apparatus; receiving the to-be-transmitted data by the second communication apparatus from the first communication apparatus; measuring the quality of the second communication by the second communication apparatus; receiving information indicating the feedback factor by the second communication apparatus from the first communication apparatus; transmitting, from the second communication apparatus to the first communication apparatus, information indicating the measured quality of the second communication on the basis of the received information indicating the feedback factor; receiving, by the first communication apparatus, the information indicating the quality of the second communication from the second communication apparatus; and controlling retransmission in the second communication by the first communication apparatus, on the basis of the received information indicating the quality of the second communication.

According to a twelfth feature of the present invention, there is provided a communication method in a communication system comprising a radio base station and a radio terminal, and configured to allow communication of data between the radio base station and the radio terminal, the method comprising the steps of: transmitting, from the radio base station to the radio terminal, information indicating a feedback factor for feedback in which the radio terminal provides feedback information on decoding for a downlink channel in the direction from the radio base station to the radio terminal; receiving the information indicating the feedback factor by the radio terminal from the radio base station; transmitting to-be-transmitted data from the radio base station to the radio terminal through the downlink channel; receiving the to-be-transmitted data by the radio terminal from the radio base station; decoding, by the radio terminal, the to-be-transmitted data received through the downlink channel; transmitting the feedback information on the decoding from the radio terminal to the radio base station through an uplink channel on the basis of the information indicating the received feedback factor; receiving the feedback information on the decoding by the radio base station from the radio terminal; and controlling retransmission in the downlink channel by the radio base station on the basis of the received feedback information on the decoding.

According to the present invention, it is possible to achieve an appropriate feedback control not hindering the data transmission.

### BRIEF DESCRIPTION OF THE DRAWINGS

FIG. 1 is an overall schematic configuration view of a communication system according to an embodiment of the present invention.

FIG. 2 is a schematic configuration view of a radio base station according to the embodiment of the present invention.

FIG. 3 is a functional block configuration view of a controller in the radio base station according to the embodiment of the present invention.

FIG. 4 is an overall schematic configuration view of a radio terminal according to the embodiment of the present invention.

FIG. 5 is a functional block diagram of a controller in the radio terminal according to the embodiment of the present invention.

FIG. 6 is a sequence diagram showing an operation of the radio communication system according to the embodiment of the present invention.

FIG. 7 is a diagram showing an HARQ packet generation step according to the embodiment of the present invention.

FIG. 8 is a diagram showing an example of an error detection according to the embodiment of the present invention.

FIG. 9 is a diagram showing an example of a likelihood detection according to the embodiment of the present invention.

FIG. 10 is a diagram showing a first configuration example of a retransmission HARQ packet according to the embodiment of the present invention.

FIG. 11 is a diagram showing a second configuration example of a retransmission HARQ packet according to the embodiment of the present invention.

FIG. 12 is a diagram showing an example of an error redetection according to the embodiment of the present invention.

FIG. 13 is a diagram showing an example of a likelihood redetection according to the embodiment of the present invention.

### DESCRIPTION OF EMBODIMENTS

An embodiment of the present invention is described below with reference to the drawings. Specifically, descriptions are given of (1) Configuration of Communication System, (2) Operation of Communication System, (3) Advantageous Effect, and (4) Other Embodiments. In the description of the drawings below, the same or similar components are given the same or similar reference numerals.

### (1) Configuration of Communication System

First, a configuration of a communication system according to the embodiment of the present invention is described in the order of (1. 1) Overall Schematic Configuration of Communication System, and (1. 2) Configuration of Communication Apparatus.

### (1. 1) Overall Schematic Configuration of Communication System

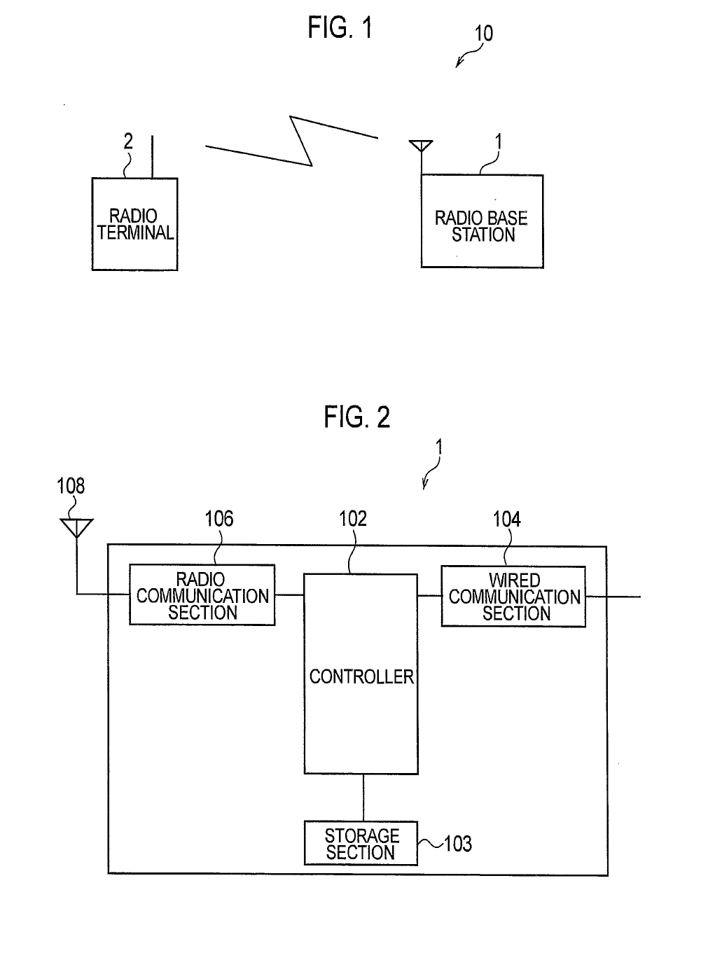

FIG. 1 is an overall schematic configuration view of a radio communication system 10 according to the embodiment of the present invention.

As shown in FIG. 1, the radio communication system 10 includes a radio base station 1 serving as a first communication apparatus and a radio terminal 2 serving as a second communication apparatus. In FIG. 1, the radio base station 1 and the radio terminal 2 transmit and receive a signal with each other.

### (1. 2) Configuration of Radio Base Station

### (1. 2. 1) Schematic Configuration View of Radio Base Station

FIG. 2 is a schematic configuration view of the radio base station 1. As shown in FIG. 2, the radio base station 1 includes a controller 102, a storage section 103, a wired communication section 104, a radio communication section 106, and an antenna 108.

The controller 102 is formed of a CPU for example, and controls various functions of the radio base station 1. The storage section 103 is formed of a memory for example, and stores therein various pieces of information used for the control and the like in the radio base station 1.

The wired communication section 104 communicates with a gateway server and the like in an unillustrated upper level network. The radio communication section 106 transmits and receives a radio signal through the antenna 108.

### (1. 2. 2) Detailed Configuration of Radio Base Station

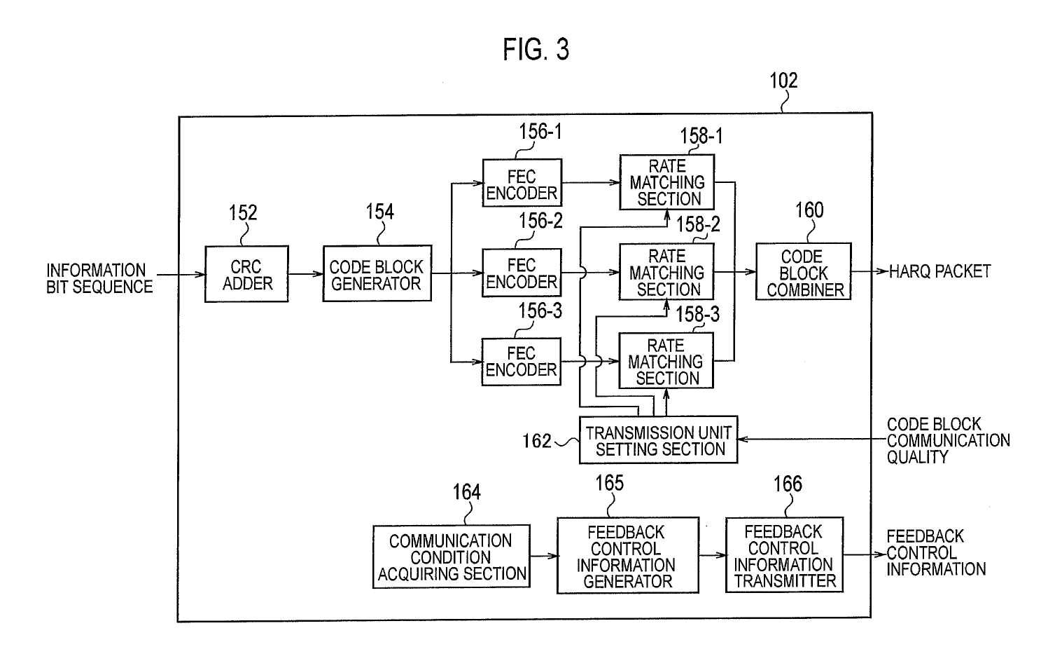

A detailed configuration of the radio base station 1, more specifically, a functional block configuration of the controller 102 is described below. FIG. 3 is a functional block diagram of the controller 102 of the radio base station 1.

As shown in FIG. 3, the controller 102 includes: a CRC adder 152; a code block generator 154; FEC encoders 156-1, 156-2, and 156-3; rate matching sections 158-1, 158-2, and 158-3; a code block combiner 160; a transmission unit setting section 162; a communication condition acquiring section 164; a feedback control information generator 165; and a feedback control information transmitter 166.

An information bit sequence is inputted to the CRC adder 152. Then, the CRC adder 152 adds the CRC bit sequence to the information bit sequence to generate a bit sequence to be transmitted. Thereafter, the CRC adder 152 outputs the bit sequence to be transmitted to the code block generator 154.

The bit sequence to be transmitted is inputted to the code block generator 154. Then, the code block generator 154 divides the bit sequence to be transmitted into blocks of a predetermined length (code blocks). In this embodiment, the code block generator 154 divides the bit sequence to be transmitted into three code blocks (code blocks #1 to #3) of a predetermined length.

Then, the code block generator 154 outputs the code block #1 to the FEC encoder 156-1. Additionally, the code block generator 154 outputs the code block #2 to the FEC encoder 156-2, and outputs the code block #3 to the FEC encoder 156-3.

The code block #1 is inputted to the FEC encoder 156-1. The FEC encoder 156-1 encodes the inputted FEC encoder 156-1. Then, the FEC encoder 156-1 outputs the encoded code block #1 to the rate matching section 158-1 on the subsequent stage. Similarly, the FEC encoder 156-2 encodes the inputted code block #2 and then, outputs the encoded code block #2 to the rate matching section 158-2 on the subsequent stage. Again similarly, the FEC encoder 156-3 encodes the inputted code block #3 and then, outputs the encoded code block #3 to the rate matching section 158-3 on the subsequent stage. The encoded code blocks #1 to #3 include identification information for identifying each of the code blocks #1 to #3.

The encoded code block #1 is inputted to the rate matching section 158-1. Next, the rate matching section 158-1 adds a redundant bit #1 to the encoded code block #1 to generate a to-be-transmitted packet #1, the redundant bit #1 being a CRC bit sequence and used for error detection. Then, the rate matching section 158-1 extracts a packet from the to-be-transmitted packet #1 by a first transmission unit at a time and outputs the packet to the code block combiner 160, the first transmission unit being set by the transmission unit setting section 162.

Similarly, the encoded code block #2 is inputted to the rate matching section 158-2. The rate matching section 158-2 adds a redundant bit #2 to the encoded code block #2 to generate a to-be-transmitted packet #2, the redundant bit #2 being a CRC bit sequence and used for error detection. Then, the rate matching section 158-2 extracts a packet from the to-be-transmitted packet #2 by a second transmission unit at a time and outputs the packet to the code block combiner 160, the second transmission unit being set by the transmission unit setting section 162. Similarly, the encoded code block #3 is inputted to the rate matching section 158-3. The rate matching section 158-3 adds a redundant bit #3 to the encoded code block #3 to generate a to-be-transmitted packet #3, the redundant bit #3 being a CRC bit sequence and used for error detection. Then, the rate matching section 158-3 extracts a packet from the to-be-transmitted packet #3 by a third transmission unit at a time and outputs the packet to the code block combiner 160, the third transmission unit being set by the transmission unit setting section 162. Note that, the redundant bit includes identification information of the encoded code block to which the redundant bit is added.

The transmission unit setting section 162 sets the first to the third transmission units described above. More particularly, the transmission unit setting section 162 sets the first to the third transmission units so that, in the initial transmission to the radio terminal 2, the first to the third transmission units have the same length and the total length of the first to the third transmission units is equal to the packet length of the HARQ packet which is fixed.

Moreover, upon receiving communication qualities of the respective code blocks #1 to #3 from the radio terminal 2 through the antenna 108 and the radio communication section 106, the transmission unit setting section 162 sets the first to the third transmission units so that, in the retransmission to the radio terminal 2, degradation levels of the communication qualities of the code blocks #1 to #3 are reflected on the ratio of the first to the third transmission units, and the total length of the first to the third transmission units is equal to the packet length of the HARQ packet which is fixed.

Here, the communication qualities of the code blocks #1 to #3 are the results of CRC check (error detection) on the code blocks #1 to #3 and the likelihoods of the code blocks #1 to #3 in the radio terminal 2.

The code block combiner 160 receives the packet of the first transmission unit extracted from the to-be-transmitted packet #1, the packet of the second transmission unit extracted from the to-be-transmitted packet #2, and the packet of the third transmission unit extracted from the to-be-transmitted packet #3. The code block combiner 160 combines the packets to generate the HARQ packet. Then, the code block combiner 160 outputs the generated HARQ packet to the radio communication section 106. Through the radio communication section 106 and the antenna 108, the HARQ packet is transmitted to the radio terminal 2 via a radio communication channel in a downlink direction (downlink communication channel) from the radio base station 1 to the radio terminal 2.

The communication condition acquiring section 164 acquires the condition of a communication channel in an uplink direction (uplink communication channel) from the radio terminal 2 to the radio base station 1. Specifically, the communication condition acquiring section 164 measures a quality of the uplink communication channel (e.g., SNR, RSSI, FER, and the like). The communication condition acquiring section 164 acquires the free capacity of the uplink communication channel. The communication condition acquiring section 164 acquires the used capacity of the uplink communication channel. The used capacity is uniquely determined according to a type of an application used for the communication in the uplink communication channel. The communication condition acquiring section 164 acquires QoS (Quality of Service) required for a communication using the uplink communication channel.

On the basis of the condition of the uplink communication channel acquired by the communication condition acquiring section 164, the feedback control information generator 165 generates feedback control information indicating a factor (hereinafter referred to as “mode”) of a feedback. The feedback is a transmission (feedback) of a code block communication quality indicating the quality of the downlink communication from the radio terminal 2 to the radio base station 1. The feedback control information includes feedback timing and a feedback information amount. The feedback timing is information indicating timing such as feedback cycle for example. The feedback information amount is information indicating the number of types of code block communication qualities. The code block communication quality is at least one of the results of error detection on the code blocks #1 to #3 and the likelihoods of the code blocks #1 to #3 in the radio terminal 2 for example.

More specifically, the feedback control information generator 165 generates feedback control information in such a manner that the worse the quality of the uplink communication channel quality, the lower the upper limit of the feedback timing and the feedback information amount. Furthermore, the feedback control information generator 165 generates feedback control information in such a manner that the smaller the free capacity of the uplink communication channel, the lower the upper limit of the feedback timing and the feedback information amount. The feedback control information generator 165 generates feedback control information in such a manner that the larger the used capacity of the uplink communication channel, the lower the upper limit of the feedback timing and the feedback information amount. The feedback control information generator 165 generates feedback control information in such a manner that the higher the QoS required for a communication using the uplink communication channel, the lower the upper limit of the feedback timing and the feedback information amount.

The feedback control information transmitter 166 transmits the feedback control information generated by the feedback control information generator 165 to the radio terminal 2 through the radio communication section 106 and the antenna 108.

### (1. 3) Configuration of Radio Terminal

### (1. 3. 1) Schematic Configuration View of Radio Terminal

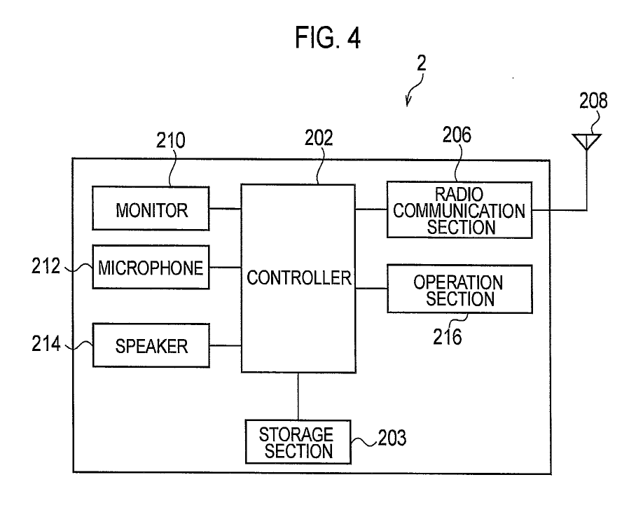

FIG. 4 is a schematic configuration view of the radio terminal 2. As shown in FIG. 4, the radio terminal 2 includes a controller 202, a storage section 203, a radio communication section 206, an antenna 208, a monitor 210, a microphone 212, a speaker 214, and an operation section 216.

The controller 202 is a CPU for example, and controls various functions of the radio terminal 2. The storage section 203 is a memory for example, and stores therein various pieces of information used for control in the radio terminal 2 and the like.

The radio communication section 206 transmits and receives a radio signal through the antenna 208.

The monitor 210 displays thereon an image and operation contents (such as inputted phone number and address.) received through the controller 202. The microphone 212 collects voices and outputs voice data based on the collected voices to the controller 202. The speaker 214 outputs the voice on the basis of the voice data acquired from the controller 202.

The operation section 216, which is formed of ten-keys, function keys, and the like, is an interface through which operation contents of a user are inputted.

### (1. 3. 2) Detailed Configuration of Radio Terminal

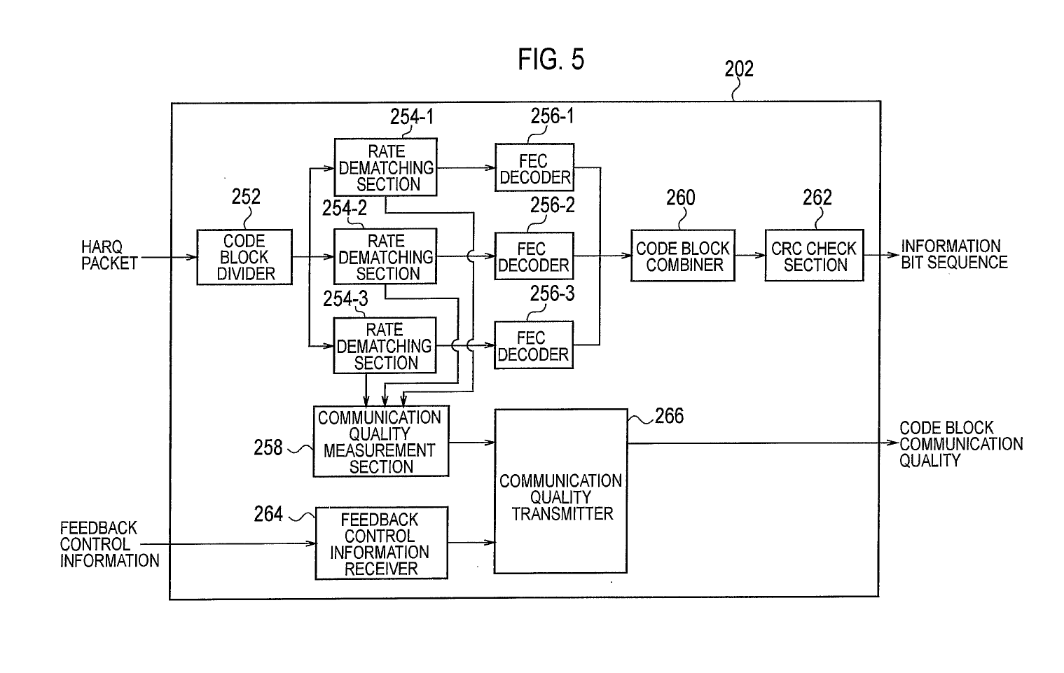

The detailed configuration of the radio terminal 2, more specifically, a functional block configuration of the controller 202 is described below. FIG. 5 is a functional block diagram of the controller 202 of the radio terminal 2.

As shown in FIG. 5, the controller 202 includes: a code block divider 252; a rate dematching sections 254-1, 254-2, 254-3; FEC decoders 256-1, 256-2, and 256-3; a communication quality measurement section 258; a code block combiner 260; a CRC check section 262; a feedback control information receiver 264; and a communication quality transmitter 266.

The code block divider 252 receives the HARQ packet transmitted from the radio terminal 1 through the antenna 208 and the radio communication section 206 via the downlink communication channel. Then, the code block divider 252 detects the identification information on the encoded code block, the identification information being included in the encoded code block in the HARQ packet, and the identification information on the encoded code block to which the redundant bit is added, the identification information being included in the redundant bit in the HARQ packet.

Then, the code block divider 252 extracts from the HARQ packet the packet of the first transmission unit, the packet including the encoded code block #1 and the redundant bit #1 that include the identification information on the code block #1. The code block divider 252 then outputs the extracted packet to the rate dematching section 254-1.

Similarly, the code block divider 252 extracts from the HARQ packet the packet of the second transmission unit, the packet including the encoded code block #2 and the redundant bit #2 that include the identification information on the code block #2. The code block divider 252 then outputs the extracted packet to the rate dematching section 254-2. Similarly, the code block divider 252 extracts from the HARQ packet the packet of the third transmission unit, the packet including the encoded code block #3 and the redundant bit #3 that include the identification information on the code block #3. The code block divider 252 then outputs the extracted packet to the rate dematching section 254-3.

The packet of the first transmission unit is inputted to the rate dematching section 254-1. The rate dematching section 254-1 extracts the code block #1 and the redundant bit #1 from the packet of the first transmission unit. Then, the rate dematching section 254-1 outputs the code block #1 to the FEC decoder 256-1 and the communication quality measurement section 258, and outputs the redundant bit #1 to the communication quality measurement section 258.

Similarly, the packet of the second transmission unit is inputted to the rate dematching section 254-2. The rate dematching section 254-2 extracts the code block #2 and the redundant bit #2 from the packet of the second transmission unit. Then, the rate dematching section 254-2 outputs the code block #2 to the FEC decoder 256-2 and the communication quality measurement section 258, and outputs the redundant bit #2 to the communication quality measurement section 258. Similarly, the packet of the third transmission unit is inputted to the rate dematching section 254-3. The rate dematching section 254-3 extracts the code block #3 and the redundant bit #3 from the packet of the third transmission unit. Then, the rate dematching section 254-3 outputs the code block #3 to the FEC decoder 256-3 and the communication quality measurement section 258, and outputs the redundant bit #3 to the communication quality measurement section 258.

The communication quality measurement section 258 receives the code block #1 and the redundant bit #1 from the rate dematching section 254-1. Similarly, the communication quality measurement section 258 receives the code block #2 and the redundant bit #2 from the rate dematching section 254-2, and receives the code block #3 and the redundant bit #3 from the rate dematching section 254-3.

Then, the communication quality measurement section 258 measures the communication qualities of the code blocks #1 to #3.

Specifically, the communication quality measurement section 258 performs: CRC check (error detection) on the code block #1 based on the redundant bit #1 which is a CRC bit sequence; the error detection on the code block #2 based on the redundant bit #2 which is a CRC bit sequence; and error detection on the code block #3 based on the redundant bit #3 which is a CRC bit sequence. Further, the communication quality measurement section 258 outputs the results of the error detections on the code blocks #1 to #3 as the communication qualities of the code blocks #1 to #3 to the communication quality transmitter 266.

The communication quality measurement section 258 detects the likelihood of the code block #1 on the basis of the redundant bit #1, the likelihood of the code block #2 on the basis of the redundant bit #2, and the likelihood of the code block #3 on the basis of the redundant bit #3. Then, the communication quality measurement section 258 outputs to the communication quality transmitter 266, the results of the likelihood detection on the code blocks #1 to #3 as the communication qualities of the code blocks #1 to #3.

The communication quality measurement section 258 outputs ACK to the communication quality transmitter 266 when all the results of the error detection on the code blocks #1 to #3 indicate that there is no error, and the results of the likelihood detection on the code blocks #1 to #3 are not smaller than a predetermined value (0.8 for example). The communication quality measurement section 258 outputs NACK to the communication quality transmitter 266 when any one of the results of the error detection on the code blocks #1 to #3 indicates that there is an error, and the results of the likelihood detection on the code blocks #1 to #3 is smaller than a predetermined value.

In addition, the FEC decoder 256-1 receives and decodes the code block #1. Further, the FEC decoder 256-1 outputs the decoded code block #1 to the code block combiner 260. The FEC decoder 256-2 receives and decodes the code block #2 and the outputs the decoded code block #2 to the code block combiner 260. The FEC decoder 256-3 receives and decodes the code block #3 and outputs the decoded code block #3 to the code block combiner 260.

The code block combiner 260 receives the decoded code blocks #1 to #3. Then, the code block combiner 260 combines the decoded code blocks #1 to #3 to generate a bit sequence to be transmitted. Further, the code block combiner 260 outputs the generated bit sequence to be transmitted to the CRC check section 262.

The CRC check section 262 receives the bit sequence to be transmitted. Then, the CRC check section 262 extracts the information bit sequence and the CRC bit sequence from the bit sequence to be transmitted and performs error detection on the information bit sequence based on the CRC bit sequence. Further, the CRC check section 262 outputs the information bit sequence if no error is detected.

The feedback control information receiver 264 receives the feedback control information from the radio base station 1 through the antenna 208 and the radio communication section 206. Then, the feedback control information receiver 264 outputs the feedback control information to the communication quality transmitter 266.

The communication quality transmitter 266 receives the communication qualities of the code blocks #1 to #3 from the communication quality measurement section 258 and the feedback control information from the feedback control information receiver 264.

Then, the communication quality transmitter 266 determines the information amount of the communication qualities of the to-be-transmitted code blocks #1 to #3 to be at the amount not larger than the upper limit of the feedback information amount indicated by the feedback control information. For example, when the upper limit of the feedback information amount is one type, the communication quality transmitter 266 determines anyone of the results of the error detection on the code blocks #1 to #3 and the results of the likelihood detection on the code blocks #1 to #3 as the communication quality of the to-be-transmitted code blocks #1 to #3.

Then, the communication quality transmitter 266 determines the feedback timing of the communication qualities of the code blocks #1 to #3 to be not larger than the upper limit of the feedback timing indicated by the feedback control information.

Then, the communication quality transmitter 206 outputs the determined communication qualities of the code blocks #1 to #3 to the radio communication section 206 at the determined feedback timing. The communication qualities of the code blocks #1 to #3 are transmitted to the radio base station 1 via the uplink communication channel, through the radio communication section 206 and the antenna 208.

The communication quality measurement section 258 outputs ACK to the radio communication section 206 when all the results of error detection on the code blocks #1 to #3 indicate that there is no error. The communication quality measurement section 258 outputs NACK to the radio communication section 206 when any one of the results of error detection on the code blocks #1 to #3 indicates that there is an error. The ACK or the NACK is transmitted to the radio terminal 2 through the radio communication section 206 and the antenna 208.

### (2) Operation in Radio Communication System

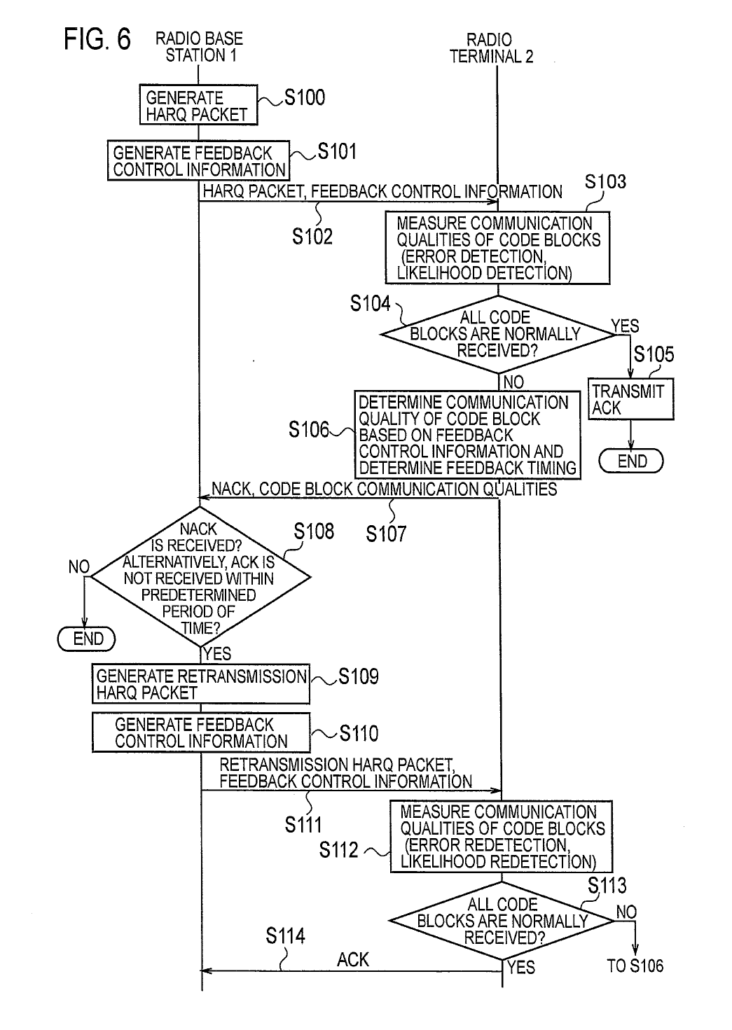

FIG. 6 is a sequence diagram showing operations of the radio base station 1 and the radio terminal 2 included in the radio communication system 10.

In Step S100, the radio base station 1 generates the HARQ packet.

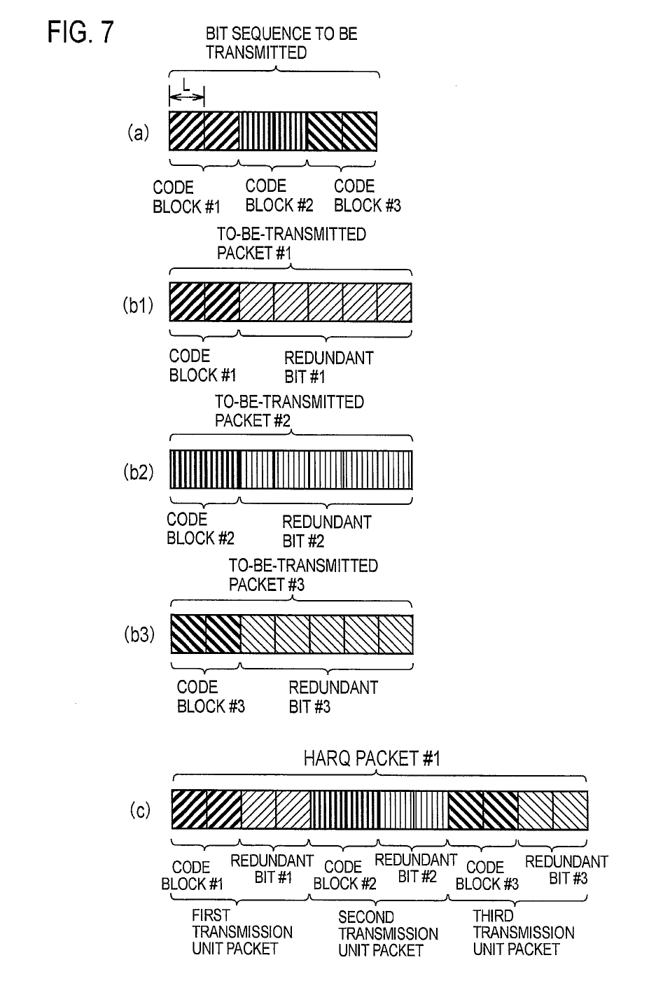

FIG. 7 is a diagram showing a HARQ packet generation step.

In the following, a block of a minimum transmission unit is assumed to have a length L. In the first step shown in FIG. 7(a), the radio base station 1 divides the bit sequence to be transmitted into the code blocks #1 to #3 each having the length 2L.

In the second step shown in FIGS. 7(b1) to (b3), the radio base station 1 adds five redundant bits #1 to the code block #1, the redundant bits #1 each being the CRC bit sequence and having the length L. Thus, the to-be-transmitted packet #1 having the length 7L is generated. Similarly, the radio base station 1 adds five redundant bits #2 to the code block #2, the redundant bits #2 each being the CRC bit sequence and having the length L. Thus, the to-be-transmitted packet #2 having the length 7L is generated. The radio terminal 1 adds five redundant bits #3 to the code block #3, the redundant bits #3 each being the CRC bit sequence and having the length L. Thus, the to-be-transmitted packet #3 having the length 7L is generated.

In the third step shown in FIG. 7(c), the transmission unit setting section 162 sets each of the first to the third transmission units to be 4L, which is one-third of the packet length of the HARQ packet. Further, the radio base station 1 extracts packets of the first to the third transmission units of 4L respectively from the head of the to-be-transmitted packets #1 to #3, and combines the packets to generate the HARQ packet #1 having the length 12L.

Referring back to FIG. 6, the radio base station 1 generates the feedback control information on the basis of the condition of the uplink communication channel in Step S101. Then, the radio base station 1 transmits the HARQ packet and the feedback control information in Step S102. The radio terminal 2 receives the HARQ packet and the feedback control information.

In Step S103, the radio terminal 2 measures the communication quality of each code block included in the HARQ packet, i.e., performs the error detection and the likelihood detection on the code blocks.

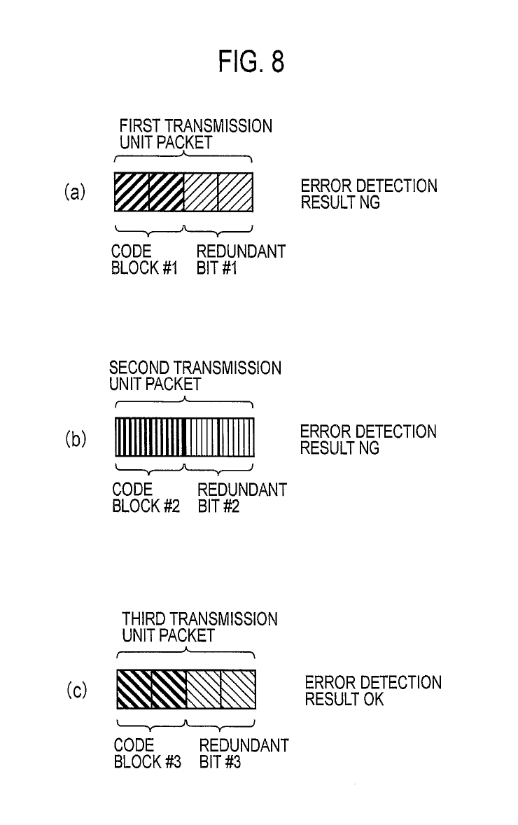

FIG. 8 is a diagram showing an example of the error detection in Step S103. As shown in FIGS. 8(a) to (c), the radio terminal 2 extracts, from the HARQ packet shown in FIG. 7(c), the packet of the first transmission unit including the code block #1 and the redundant bit #1, the packet of the second transmission unit including the code block #2 and the redundant bit #2, and the packet of the third transmission unit including the code block #3 and the redundant bit #3.

Subsequently, the radio terminal 2 performs the error detection on the code block #1 on the basis of the redundant bit #1. Similarly, the radio terminal 2 performs the error detection on the code block #2 on the basis of the redundant bit #2, and performs the error detection on the code block #3 on the basis of the redundant bit #3. In FIG. 8, an error is detected in the code blocks #1 and #2 (error detection result is NG) and no error is detected in the code block #3 (error detection result is OK).

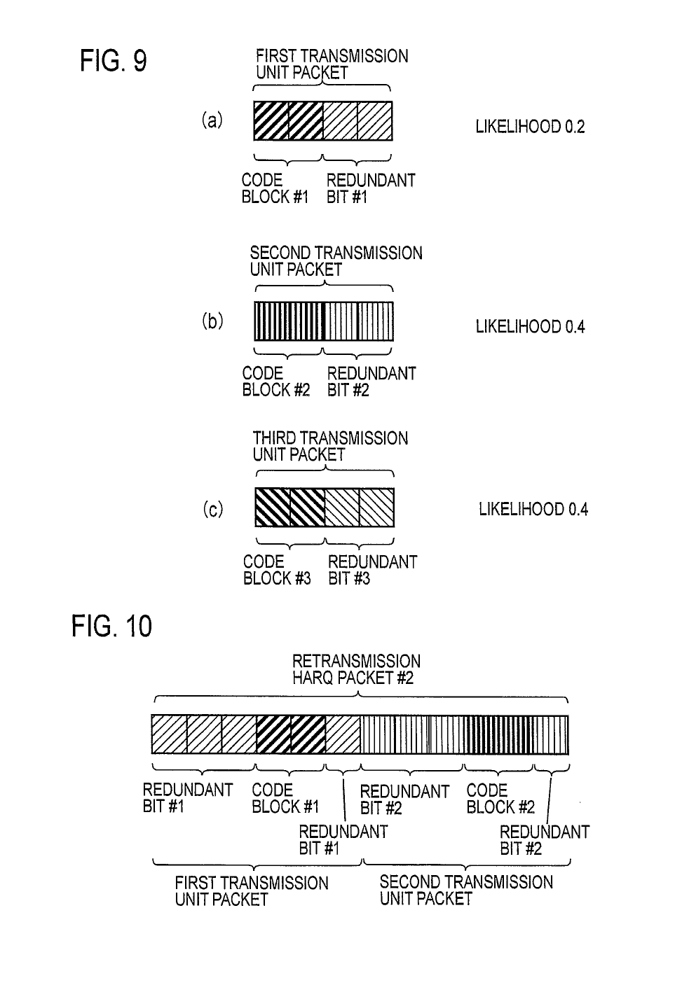

FIG. 9 is a diagram showing an example of the likelihood detection in Step S103. As shown in FIGS. 9(a) to 9(c), the radio terminal 2 extracts from the HARQ packet shown in FIG. 7(c), a packet of a first transmission unit including the code block #1 and the redundant bit #1, a packet of a second transmission unit including the code block #2 and the redundant bit #2, and a packet of a third transmission unit including the code block #3 and the redundant bit #3.

Subsequently, the radio terminal 2 performs the likelihood detection on the code block #1 on the basis of the redundant bit #1. Similarly, the radio terminal 2 performs the likelihood detection on the code block #2 on the basis of the redundant bit #2, and performs the likelihood detection on the code block #3 on the basis of the redundant bit #3. In FIG. 9, the likelihood of the code block #1 is 0.2 and the likelihoods of the code blocks #2 and #3 are 0.4.

Referring back to FIG. 6, the radio terminal 2 determines whether or not all the code blocks are normally received in Step S104 on the basis of the error detection results and the likelihood detection results in Step S103. Specifically, the radio terminal 2 determines that all the code blocks are normally received when the error detection results on the code blocks are all OK and the likelihoods of all the code blocks are not smaller than the predetermined value.

If all the code blocks are normally received, the radio terminal 2 transmits ACK to the radio base station 1 in Step S105. Thus, the series of operations are completed.

When there is a code block not received normally (NO in Step S104), the radio terminal 2 determines the communication quality of the to-be-transmitted code block on the basis of the feedback control information and determines the feedback timing of the communication quality of the to-be-transmitted code block.

The communication quality transmitter 266 in the radio terminal 2 reads out predetermined feedback control information from the storage section 203 for example when the radio terminal 2 cannot receive the feedback information within a predetermined period of time after the reception of the HARQ packet in Step S102. Then, the communication quality transmitter 266 determines the communication quality of the to-be-transmitted code block on the basis of the read-out feedback control information and determines the feedback timing of the communication quality of the to-be-transmitted code block.

In Step S107, the radio terminal 2 transmits NACK to the radio base station 1. The radio base station 1 receives the NACK. Then, when the feedback timing determined in Step S106 comes, the radio terminal 2 transmits the communication quality of the to-be-transmitted code block determined in Step S106. The radio base station 1 receives information indicating the code block communication quality.

For example, when the communication quality of the to-be-transmitted code block is the error detection result, the radio terminal 2 transmits the code block communication quality indicating that the results of the error detection on the code blocks #1 and #2 are NG and the result of the error detection on the code block #3 is OK in the example of FIG. 8.

When the communication quality of the to-be-transmitted code block is the likelihood, the radio terminal 2 transmits the code block communication quality indicating that the likelihood of the code block #1 is 0.2 and the likelihoods of the code blocks #2 and #3 are 0.4 in the example of FIG. 9.

Referring back to FIG. 6, the radio base station 1 determines whether or not the NACK is received from the radio terminal 2 or whether no ACK is received within a predetermined period of time in Step S108. When no NACK is received and ACK is received within the predetermined period of time, the radio base station 1 terminates the series of operations.

Conversely, when receiving NACK from the radio terminal 2 or receiving no ACK from the radio terminal 2 within a predetermined period of time, the radio base station 1 generates a retransmission HARQ packet in Step S109.

FIG. 10 is a diagram showing a first configuration example of the retransmission HARQ packet. FIG. 9 shows an example where the results of the error detection on the code blocks #1 and #2 are NG and the result of the error detection on the code block #3 is OK in radio terminal 2 as shown in FIG. 8.

In this case, retransmission is required for the code blocks #1 and #2 but not required for the code block #3. Thus, the radio base station 1 sets each of the first and the second transmission units to be 6L which is the half of the packet length of the HARQ packet. Then, the radio base station 1 extracts from the to-be-transmitted packet #1, 6L of blocks starting from the block after the rear-most block in the blocks that have been transmitted the last time. Similarly, the radio base station 1 extracts from the to-be-transmitted packet #2, 6L of blocks starting from the block after the rear-most block in the blocks that have been transmitted the last time. Further, the radio base station 1 combines packets of the first and the second transmission units of 6L respectively extracted from the to-be-transmitted packets #1 and #2 to generate a retransmission HARQ packet #2 having the length 12L.

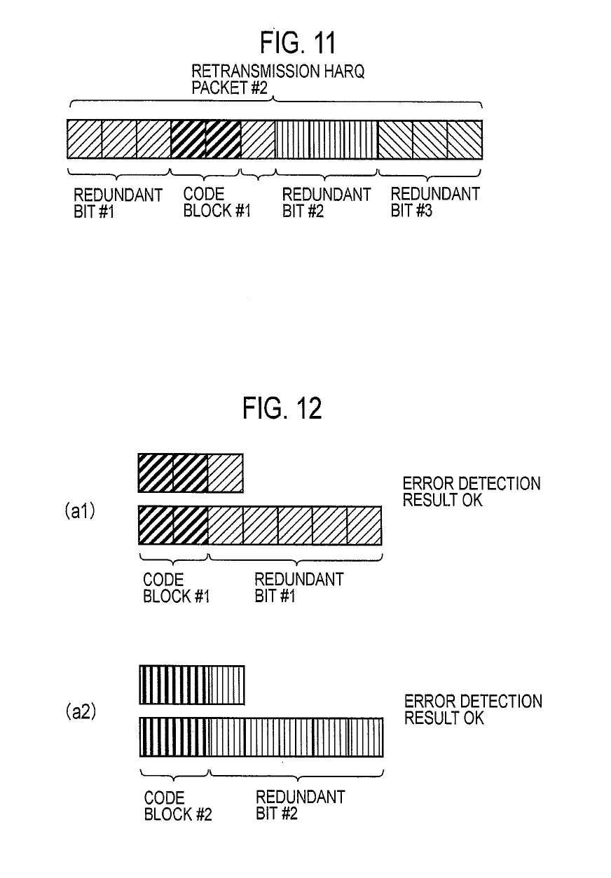

FIG. 11 is a diagram showing a second configuration example of the retransmission HARQ packet. FIG. 9 shows an example where the likelihood of the code block #1 in the radio terminal 2 is 0.2 and the likelihoods of the code blocks #2 and #3 in the radio terminal 2 are 0.4 as shown in FIG. 9.

In this case, the radio base station 1 sets the ratio among the first to the third transmission units to be 1/0.2:1/0.4:1/0.4, i.e., 2:1:1. Then, the radio base station 1 sets the first transmission unit to be 6L which is half of the packet length of the HARQ packet. Then, the radio terminal 1 extracts from the to-be-transmitted packet #1, 6L of blocks starting from the block after the rear-most block in the blocks that have been transmitted the last time. The radio terminal 1 extracts from the to-be-transmitted packet #2, 3L of blocks starting from the block after the rear-most block in the blocks that have been transmitted the last time. Similarly, the radio terminal 1 extracts from the to-be-transmitted packet #3, 3L of blocks starting from the block after the rear-most block in the blocks that have been transmitted the last time.

Furthermore, the radio terminal 1 combines packets of the first transmission unit which is 6L of blocks extracted from the to-be-transmitted packet #1, the packet of the second transmission unit which is 3L of blocks extracted from the to-be-transmitted packet #2, and the packet of the third transmission unit which is 3L of blocks extracted from the to-be-transmitted packet #3 to generate a retransmission HARQ packet #2 having the length 12L.

Referring back to FIG. 6, the radio base station 1 generates the feedback control information on the basis of the condition of the uplink communication channel in Step S110. Then, the radio base station 1 transmits the retransmission HARQ packet and the feedback control information in Step S111. The radio terminal 2 receives the retransmission HARQ packet and the feedback control information.

In Step S112, the radio terminal 2 performs remeasurement on the communication quality of the code blocks included in the HARQ packet received in Step S102 and the code blocks included in the retransmission HARQ packet received in Step S111.

FIG. 12 is a diagram showing an example of a case where remeasurement on the communication quality of the code blocks is an error redetection in Step S110. As shown in FIG. 12(a1), the radio terminal 2 combines the code block #1 and the redundant bit #1 received in Step S102 with the code block #1 and the redundant bit #1 received in Step S111. Here, the code block #1 and the redundant bit #1 are each received twice. In this case, the radio terminal 2 combines the Euclidean distances of the bit at the same position in the two code blocks #1 and the two redundant bits #1. The radio terminal 2 determines each bit of the code block #1 and the redundant bit #1 received twice based on the combined value of the Euclidean distances. The radio terminal 2 performs the error detection on the code block #1 based on the redundant bit #1.

Similarly, the radio terminal 2 combines the code blocks #2 and the redundant bits #2 received in Step 102 and the Step S111 as shown in FIG. 12(a2). Then, the radio terminal 2 determines each bit of the code blocks #2 and the redundant bits #2 received twice. Subsequently, the radio terminal 2 performs error detection on the code block #2 on the basis of the redundant bit #2.

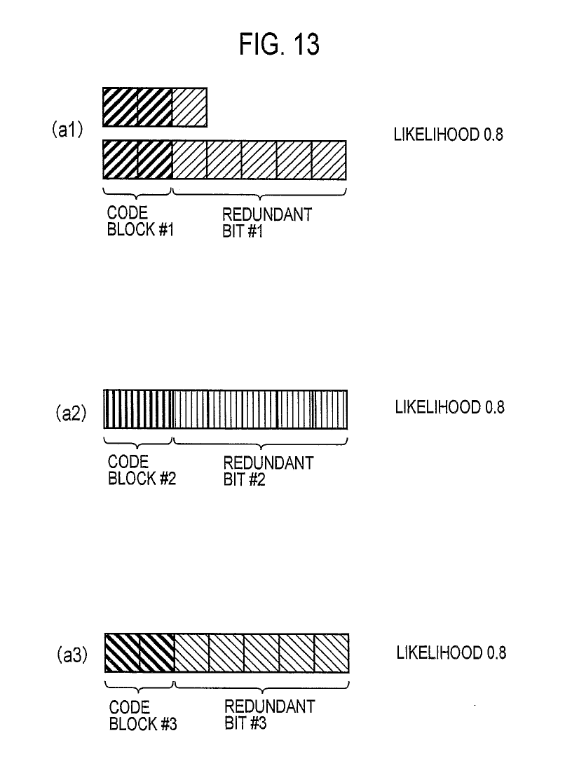

FIG. 13 is a diagram showing an example of a case where remeasurement on the communication quality of the code blocks is a likelihood redetection. As shown in FIG. 13(a1), the radio terminal 2 combines the pre-received code block #1 and the redundant bit #1 with the newly received code block #1 and the redundant bit #1. Here, the code block #1 and the redundant bit #1 are both received twice. In this case, the radio terminal 2 combines the Euclidean distances of the bit at the same position in the two code blocks #1 and the two redundant bits #1. The radio terminal 2 determines each bit of the code block #1 and the redundant bit #1 received twice based on the combined value of the Euclidean distances. Furthermore, the radio terminal 2 detects the likelihood of the code block #1 based on the redundant bit #1.

In addition, as shown in FIG. 13(a2), the radio terminal 2 combines the pre-received code block #2 and the redundant bit #2 with the newly received redundant bit #2 to detect the likelihood of the code block #2 based on the redundant bit #2. Similarly, as shown in FIG. 13(a3), the radio terminal 2 combines the pre-received code block #3 and the redundant bit #3 with the newly received redundant bit #3 to detect the likelihood of the code block #3 based on the redundant bit #3.

Referring back to FIG. 6, the radio terminal 2 determines whether or not all the code blocks are normally received in Step S113 on the basis of the results in the remeasurement on the code block communication quality in Step S112. The specific determination operation is similar to that in Step S104.

If all the code blocks are normally received, the radio terminal 2 transmits ACK and the radio base station 1 receives the ACK in Step S114. Thus, the series of operations are completed.

When there is a code block not received normally (NO in Step S113), the following operations are repeated in Step S106 again. Specifically, the radio terminal 2 determines the communication quality of the to-be-transmitted code block on the basis of the feedback control information and determines the feedback timing of the communication quality of the to-be-transmitted code block.

### (3) Advantageous Effect

In the radio communication system 10 according to the embodiment of the present invention, the radio base station 1 determines the upper limit of the feedback timing and the information amount for the code block communication quality of the radio terminal 2 on the basis of the condition of the uplink communication channel, the code block communication quality being a quality of the downlink communication channel. Then, the radio base station 1 transmits the feedback control information including the upper limit of the feedback timing and the information amount to the radio terminal 2. Meanwhile, the radio terminal 2 determines the timing and the information amount for the feedback to be not larger than the upper limit of the timing and the information amount for the feedback included in the received feedback control information. Then, the radio terminal 2 transmits the code block communication quality that is the quality of the downlink communication channel to the radio base station 1 using the uplink communication channel. The radio base station 1 controls the retransmission of the code block on the basis of the received code block communication quality.

Thus, the radio terminal 2 can transmit the code block communication quality that is the quality of the downlink communication channel using the uplink communication channel in accordance with the feedback mode based on the condition of the uplink communication channel. Accordingly, an appropriate feedback control not hindering the transmission of voice data and the like using the uplink communication channel can be achieved.

The radio base station 1 generates the feedback control information in such a manner that the worse the quality of the uplink communication channel, the lower the upper limit of the feedback timing and the feedback information amount. The radio base station 1 generates the feedback control information in such a manner that the smaller the free capacity of the uplink communication channel, the lower the upper limit of the feedback timing and the feedback information amount. The radio base station 1 generates the feedback control information in such a manner that the larger the used capacity of the uplink communication channel, the lower the upper limit of the feedback timing and the feedback information amount. The radio base station 1 generates the feedback control information in such a manner that the higher the QoS required for the communication using the uplink communication channel, the lower the upper limit of the feedback timing and the feedback information amount. As described above, the feedback control information is generated on the basis of the various parameters of the condition of the upper link communication channel, and thus more suitable feedback control can be achieved.

### (4) Other Embodiment

As described above, the details of the present invention have been disclosed by using the second embodiment of the present invention. However, it should not be understood that the description and drawings which constitute part of this disclosure limit the present invention. From this disclosure, various alternative embodiments, examples, and operation techniques will be easily found by those skilled in the art.

In the embodiment, the communication quality of a code block is the result of error detection on the code block and the likelihood of the code block in the radio terminal 2. Instead, the communication quality of the code block may be SNR, RSSI, FER, and the like.

In the embodiment, the radio base station 1 serves as the first communication apparatus and the radio terminal 2 serves as the second communication apparatus. However, the present invention can be similarly applied to the case where the radio terminal 2 serves as the first communication apparatus and the radio base station 1 serves as the second communication apparatus.

In this case the radio terminal 2 determines the upper limit of the feedback timing and the information amount for the feedback of the code block communication quality that is a quality of the upper communication channel of the radio base station 1, on the basis of the condition of the downlink communication channel. Then, the radio terminal 2 transmits the feedback control information including the upper limit of the feedback timing and the information amount to the radio base station 1. Meanwhile, the radio base station 1 determines the timing and the information amount for the feedback to be not larger than the upper limit of the timing and the information amount for the feedback included in the received feedback control information. Then, the radio base station 1 transmits the code block communication quality that is a quality of the uplink communication channel to the radio terminal 2 using the downlink communication channel.

Note that the entire contents of Japanese Patent Application No. 2009-043177 (filed on Feb. 25, 2009) are incorporated herein by reference.

### INDUSTRIAL APPLICABILITY

The communication system, the communication apparatus, and the communication method of the present invention can achieve appropriate feedback control not hindering the data transmission, and thus are useful as a communication system and the like.

1. A communication system comprising a first communication apparatus and a second communication apparatus and configured to allow communication of data between the first communication apparatus and the second communication apparatus, wherein
the first communication apparatus comprises:
a determination section configured to determine a feedback factor for feedback in which the second communication apparatus provides the first communication apparatus with information indicating a quality of second communication in the direction from the first communication apparatus to the second communication apparatus, on the basis of a condition of a first communication in the direction from the second communication apparatus to the first communication apparatus;
a data transmitter configured to transmit to-be-transmitted data to the second communication apparatus; and
a feedback factor transmitter configured to transmit information indicating the feedback factor determined by the determination section to the second communication apparatus,
the second communication apparatus comprises:
a data receiver configured to receive the to-be-transmitted data from the first communication apparatus;
a measurement section configured to measure the quality of the second communication;
a feedback factor receiver configured to receive information indicating the feedback factor from the first communication apparatus; and
a quality transmitter configured to transmit, to the first communication apparatus, information indicating the quality of the second communication measured by the measurement section on the basis of the information indicating the feedback factor received by the feedback factor receiver, and
the first communication apparatus further comprises:
a quality receiver configured to receive the information indicating the quality of the second communication from the second communication apparatus; and
a retransmission controller configured to control retransmission in the second communication on the basis of the information indicating the quality of the second communication received by the quality receiver.

2. A communication apparatus configured to perform communication of data with a different communication apparatus, the communication apparatus comprising:
a determination section configured to determine a feedback factor of information indicating a quality of second communication in the direction from the communication apparatus to the different communication apparatus, on the basis of a condition of a first communication in the direction from the different communication apparatus to the communication apparatus;
a data transmitter configured to transmit to-be-transmitted data to the different communication apparatus;
a feedback factor transmitter configured to transmit information indicating the feedback factor determined by the determination section to the different communication apparatus;
a quality receiver configured to receive the information indicating the quality of the second communication transmitted from the different communication apparatus; and
a retransmission controller configured to control retransmission in the second communication on the basis of the information indicating the quality of the second communication received by the quality receiver.

3. The communication apparatus according to claim 2, wherein
the determination section determines the feedback factor in such a manner that the worse the quality in the first communication is, the more the timing and amount of information are limited for the feedback in which the different communication apparatus provides the information indicating the quality of the second communication.

4. The communication apparatus according to claim 2, wherein
the determination section determines the feedback factor in such a manner that the smaller the free capacity in the first communication is, the more the timing and amount of information are limited for the feedback in which the different communication apparatus provides the information indicating the quality of the second communication.

5. The communication apparatus according to claim 2, wherein
the determination section determines the feedback factor in such a manner that the larger the used capacity in the first communication by the other communication apparatus is, the more the timing and amount of information are limited for the feedback of the information indicating the quality of the second communication.

6. The communication apparatus according to claim 2, wherein
the determination section determines the feedback factor in such a manner that the higher the QoS required for a communication using the first communication by the different communication apparatus is, the more the timing and amount of information are limited for the feedback of the information indicating the quality of the second communication.

7. The communication apparatus according to claim 2, wherein
the communication apparatus communicates packets including a plurality of code blocks obtained by dividing a bit sequence, with the different communication apparatus, and
the determination section determines the factor for the feedback of the information indicating the quality of the code blocks.

8. A communication apparatus configured to perform communication of data with a different communication apparatus, the communication apparatus comprising:
a data receiver configured to receive to-be-transmitted data from the different communication apparatus;
a measurement section configured to measure the quality of a first communication in the direction from the different communication apparatus to the communication apparatus;
a feedback factor receiver configured to receive from the different communication apparatus, information indicating a feedback factor for information indicating a quality of a second communication in the direction from the communication apparatus to the different communication apparatus; and
a quality transmitter configured to transmit, to the different communication apparatus, information indicating the quality of the first communication measured by the measurement section, on the basis of the information indicating the feedback factor received by the feedback factor receiver.

9. The communication apparatus according to claim 8, wherein
when the feedback factor receiver receives no information indicating the feedback factor within a predetermined period of time after the data receiver receives the to-be-transmitted data, the quality transmitter transmits, to the first communication apparatus, the information indicating the quality of the first communication measured by the measurement section, on the basis of a specific feedback factor.

10. The communication apparatus according to claim 8, wherein
the communication apparatus communicates packets including a plurality of code blocks obtained by dividing a bit sequence, with the other communication apparatus, and
the measurement section measures the quality of the code blocks.

11. A communication method in a communication system comprising a first communication apparatus and a second communication apparatus and configured to allow communication of data between the first communication apparatus and the second communication apparatus, the method comprising the steps of:
determining, by the first communication apparatus, a feedback factor for feedback in which the second information apparatus provides the first communication apparatus with information indicating a quality of second communication in the direction from the first communication apparatus to the second communication apparatus, on the basis of a condition of a first communication in the direction from the second communication apparatus to the first communication apparatus;
transmitting to-be-transmitted data from the first communication apparatus to the second communication apparatus; transmitting information indicating the determined feedback factor from the first communication apparatus to the second communication apparatus;
receiving the to-be-transmitted data by the second communication apparatus from the first communication apparatus;
measuring the quality of the second communication by the second communication apparatus;
receiving information indicating the feedback factor by the second communication apparatus from the first communication apparatus;
transmitting, from the second communication apparatus to the first communication apparatus, information indicating the measured quality of the second communication on the basis of the received information indicating the feedback factor;
receiving, by the first communication apparatus, the information indicating the quality of the second communication from the second communication apparatus; and
controlling retransmission in the second communication by the first communication apparatus, on the basis of the received information indicating the quality of the second communication.

12. A communication method in a communication system comprising a radio base station and a radio terminal, and configured to allow communication of data between the radio base station and the radio terminal, the method comprising the steps of:
transmitting, from the radio base station to the radio terminal, information indicating a feedback factor for feedback in which the radio terminal provides feedback information on decoding for a downlink channel in the direction from the radio base station to the radio terminal;
receiving the information indicating the feedback factor by the radio terminal from the radio base station;
transmitting to-be-transmitted data from the radio base station to the radio terminal through the downlink channel;
receiving the to-be-transmitted data by the radio terminal from the radio base station;
decoding, by the radio terminal, the to-be-transmitted data received through the downlink channel;
transmitting the feedback information on the decoding from the radio terminal to the radio base station through an uplink channel on the basis of the information indicating the received feedback factor;
receiving the feedback information on the decoding by the radio base station from the radio terminal; and
controlling retransmission in the downlink channel by the radio base station on the basis of the received feedback information on the decoding.
